(19) United States
(12) Patent Application Publication
(10) Pub. No.: US 2016/0162743 A1
(43) Pub. Date: Jun. 9, 2016

(54) VEHICLE VISION SYSTEM WITH SITUATIONAL FUSION OF SENSOR DATA

(71) Applicant: MAGNA ELECTRONICS INC., Auburn Hills, MI (US)

(72) Inventors: William J. Chundrlik, JR., Rochester Hills, MI (US); Dominik Raudszus, Aachen (DE)

(21) Appl. No.: 14/957,708

(22) Filed: Dec. 3, 2015

Related U.S. Application Data
(60) Provisional application No. 62/088,130, filed on Dec. 5, 2014.

(51) Int. Cl. G06K 9/00; G01S 17/02; B60R 1/00; G01S 13/86; G06T 7/20; H04N 7/18

(52) U.S. Cl. CPC G06K 9/00805; G06T 7/208; H04N 7/185; B60R 1/00; G01S 13/867; G01S 17/023; G06T 2207/10032; G06T 2207/30232; G06T 2207/30236; G06T 2207/30241; B60R 2300/301

(57) ABSTRACT

A vision system of a vehicle includes a camera and a non-imaging sensor. With the camera and the non-imaging sensor disposed at the vehicle, the field of view of the camera at least partially overlaps the field of sensing of the non-imaging sensor at an overlapping region. A processor is operable to process image data captured by the camera and sensor data captured by the non-imaging sensor to determine a driving situation of the vehicle. Responsive to determination of the driving situation, Kalman Filter parameters associated with the determined driving situation are determined and, using the determined Kalman Filter parameters, a Kalman Filter fusion may be determined. The determined Kalman Filter fusion may be applied to captured image data and captured sensor data to determine an object present in the overlapping region.

### CROSS REFERENCE TO RELATED APPLICATION

The present application is related to U.S. provisional application, Ser. No. 62/088,130, filed Dec. 5, 2014, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

The present invention provides a collision avoidance system or vision system or imaging system for a vehicle that utilizes one or more cameras (preferably one or more CMOS cameras) to capture image data representative of images exterior of the vehicle, and utilizes one or more non-imaging sensors (such as a radar sensor or lidar sensor or the like) to capture sensor data representative of a sensed area exterior of the vehicle. The system processes captured image data and captured sensor data to match objects present in the viewing areas of the camera and sensor, and determines a driving condition or situation or classification of matched objects. Responsive to the determination, the system selects an appropriate Kalman Filter parameter (such as an appropriate gain and/or covariance associated with the classified object) and applies or performs an appropriate Kalman Filter fusion (utilizing the determined or selected appropriate Kalman Filter parameter or parameters) to the data for the respective determined classification of the object.

The system (such as a processor or control of the system) may process image data and sensor data to match objects present in the field of view of the camera and the field of sensing of the sensor, and, responsive to matching of objects, the system determines if the matched objects are stationary or moving and selects an appropriate Kalman Filter parameter associated with the determined matched objects and applies an appropriate Kalman Filter fusion. Also, responsive to matching of objects, the system may determine if a moving object is indicative of an approaching head-on vehicle and, responsive to determination that the moving object is indicative of an approaching head-on vehicle, the system selects an appropriate Kalman Filter parameter associated with an approaching head-on vehicle and applies the associated or appropriate Kalman Filter fusion to the image data and sensor data. Also, responsive to matching of objects, the system may determine that a moving object is not indicative of an approaching head-on vehicle and may select an appropriate Kalman Filter parameter associated with other object motion and may apply the associated or appropriate Kalman Filter fusion to the image data and sensor data.

The non-imaging sensor comprises a one of a radar sensor, a lidar sensor, and an ultrasonic sensor. The processor of the system may be operable to communicate via a vehicle-to-vehicle communication system of the vehicle. The camera may have a field of view forward of the vehicle and the non-imaging sensor may have a field of sensing forward of the vehicle, with the fields of view/sensing at least partially overlapping one another.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates a camera and a non-imaging sensor in accordance with the present invention;

FIG. 2 is a schematic of the system of the present invention; and

FIG. 3 is a flowchart showing the process of the system of the present invention.

### DESCRIPTION OF THE PREFERRED EMBODIMENTS

A vehicle vision system and/or driver assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a forward or rearward direction. The vision system includes an image processor or image processing system that is operable to receive image data from one or more cameras (and optionally may provide an output to a display device for displaying images representative of the captured image data). Optionally, the vision system may provide a top down or bird's eye or surround view display and may provide a displayed image that is representative of the subject vehicle, and optionally with the displayed image being customized to at least partially correspond to the actual subject vehicle.

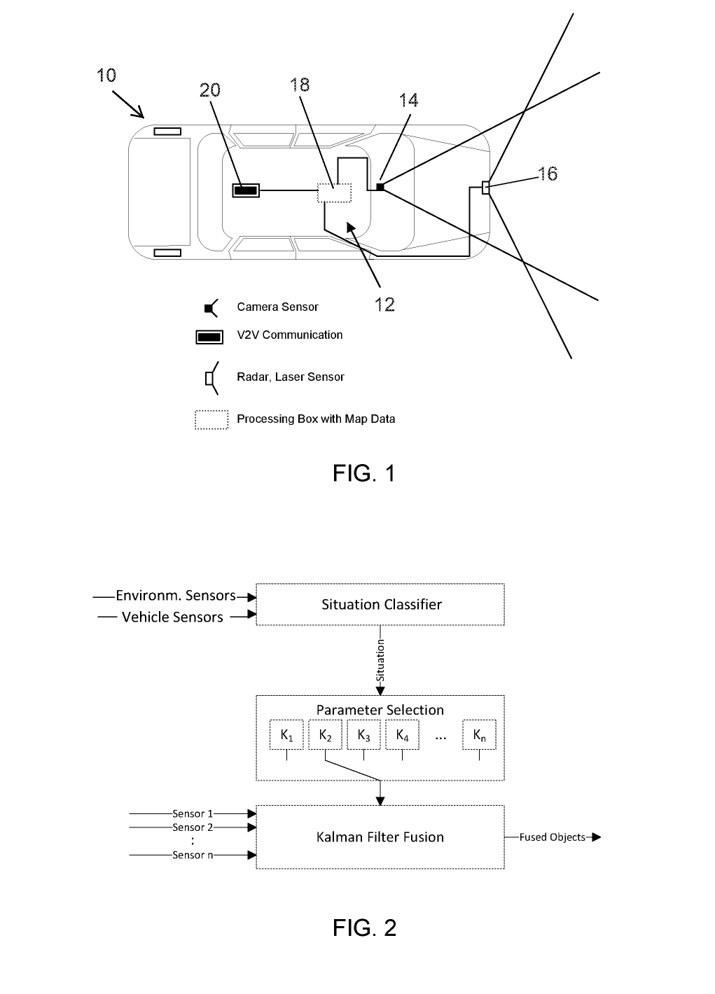

Referring now to the drawings and the illustrative embodiments depicted therein, a vehicle 10 includes an imaging system or vision system 12 that includes at least one exterior facing imaging sensor or camera, such as a forward facing imaging sensor or camera 14 (and the system may optionally include multiple exterior facing imaging sensors or cameras, such as a rearwardly facing camera at the rear of the vehicle, and a sidewardly/rearwardly facing camera at respective sides of the vehicle), which captures images exterior of the vehicle, with the camera having a lens for focusing images at or onto an imaging array or imaging plane or imager of the camera (FIG. 1). The system also includes a forward sensing sensor 16, such as a radar sensor or lidar sensor or the like. The vision system 12 includes a control or electronic control unit (ECU) or processor 18 that is operable to process image data captured by the cameras and may provide displayed images at a display device for viewing by the driver of the vehicle. The data transfer or signal communication from the camera to the ECU may comprise any suitable data or communication link, such as a vehicle network bus or the like of the equipped vehicle. The control unit or processor 18 may also be in communication with a vehicle to vehicle (V2V) or vehicle to infrastructure (V2X) communication system or device or link 20 or the like (to communicate with other vehicle or infrastructure communication devices). The system may utilize aspects of the systems described in U.S. Pat. No. 8,013,780, which is hereby incorporated herein by reference in its entirety.

Many types of driver assistance systems require information regarding the location and motion of host and surrounding vehicles traversing roadways. Typical data fusion strategies combine data derived from disparate environment sensory data (e.g., radar and camera) sources. The resulting fused output in some sense is better than what would be possible when these sources were used individually. This fusion technique confirms all the sensor data is valid and followed by a data association function used to determine which objects reported by the different sensor technologies are related to each other. These processing steps are followed by a fusion function, typically performed by a Kalman filter.

The standard or extended Kalman filter is very math and time intensive which can drive processor and memory complexity. A steady state Kalman filter significantly reduces the processor and memory complexity. This technique utilizes a fixed gain which includes covariance values. The approach generally works well in situations where input data does not have significant changes in attributes, such as, for example, relative velocity between ±50 m/sec. Utilizing the same steady state Kalman filter in situations where an on-coming vehicle with a significantly larger relative velocity is reported for a short period of time can generate errors. While this may not be a common situation, it can affect the overall fusion output performance. Detecting this situation and utilizing a different set of gain values related to detecting this situation improves fusion output performance.

A conventional Kalman Filter implementation performs a model-based prediction (such as shown in Equation (1) below) of the system state \hat{x} incorporating the system matrix Aₖ and subsequently corrects this prediction taking measured sensor data yₖ into account (see equation (2) below). The weighting between prediction and measurement depends on the Kalman Gain Kₖ which is calculated in every time step based on measurement error covariance Rₖ (which might change in different situations) according to equation (3) below. Cₖ represents the measurement matrix and Pₖ estimate error covariance. By this means, Kalman filter behavior is dynamically adapted to the driving situation. This approach, however, is demanding with regards to processing power, as matrix inversion needs to be performed in every time step. The prediction equation (4) below of the estimated error covariance Pₖ₊₁⁻ is based on the current estimated error covariance (Pₖ), the system matrix (Aₖ) and process noise (Qₖ). The prediction equation (4) is calculated in every time step and is utilized in calculating the Kalman gain equation (3).

\hat{x}ₖ₊₁⁻=Aₖ\hat{x}ₖ (1)

\hat{x}ₖ=\hat{x}ₖ⁻+Kₖ(yₖ−Cₖ\hat{x}ₖ⁻) (2)

Kₖ=Pₖ⁻Cₖ^{T}(CₖPₖ⁻Cₖ^{T}+Rₖ)⁻¹ (3)

Pₖ₊₁⁻=AₖPₖAₖ^{T}+Qₖ (5)

The equations (2) and (3) above are related to a Kalman Filter with only one measurement input, such as a single sensor, in order to illustrate the algorithm in a clear and simple manner. However, the approach is not limited to a single sensor but may utilize two or more sensors and thus a separate Kalman gain for each sensor input.

In order to avoid matrix inversion, a steady state Kalman filter with a fixed Kalman gain can be used instead of frequently recalculating Kalman gain. According to an aspect of the present invention, a situation-dependent adaptation of the Kalman filter behavior is performed by dynamically changing the gain values of the steady state Kalman Filter based on the object dynamics of the associated camera and radar object data. The object dynamics are predetermined and defined as a set of calibrations. These can include but are not limited to a preceding vehicle approaching head-on, a preceding stopped vehicle, or a preceding close-cutting in vehicle.

Sensors used in the system of the present invention are based on two or more disparate technology sources, such as, for example, radar sensors and camera. However, the system of the present invention is not limited to a camera and radar. The system may function with a camera and laser sensor or lidar sensor, or a camera and vehicle to vehicle (v2v) communicated data (such as shown in FIG. 1) or the like. The processor performs sensor operational checks, data validity checks, and calculations that fuse the associated radar and camera object location and motion data utilizing a steady state Kalman filter with constant gain calibration values.

Using a steady state Kalman filter eliminates the gain and covariance calculations. This strategy could limit the overall accuracy of the fused object output data based on all driving situations. These errors may be situation dependent. Therefore, if these situations are identified, a separate set of gain calibrations may be used in the filter calculations, and a reduction in output data error can be achieved.

The present invention provides a strategy to use a separate set of gain calibrations in situations where a single general set of calibrations introduces excessive error in the overall output data. The fusion of the system of the present invention focuses on the Kalman filter strategy and does not take into account object association and data validity functionality.

The basic structure of situation specific fusion is illustrated in FIG. 2. Based on environmental sensors, which may comprise a camera, radar or lidar or any other sensor, the current situation is determined by a situation classifier. Based on the determined situation, a Kalman gain is selected and passed to the Kalman filter fusion.

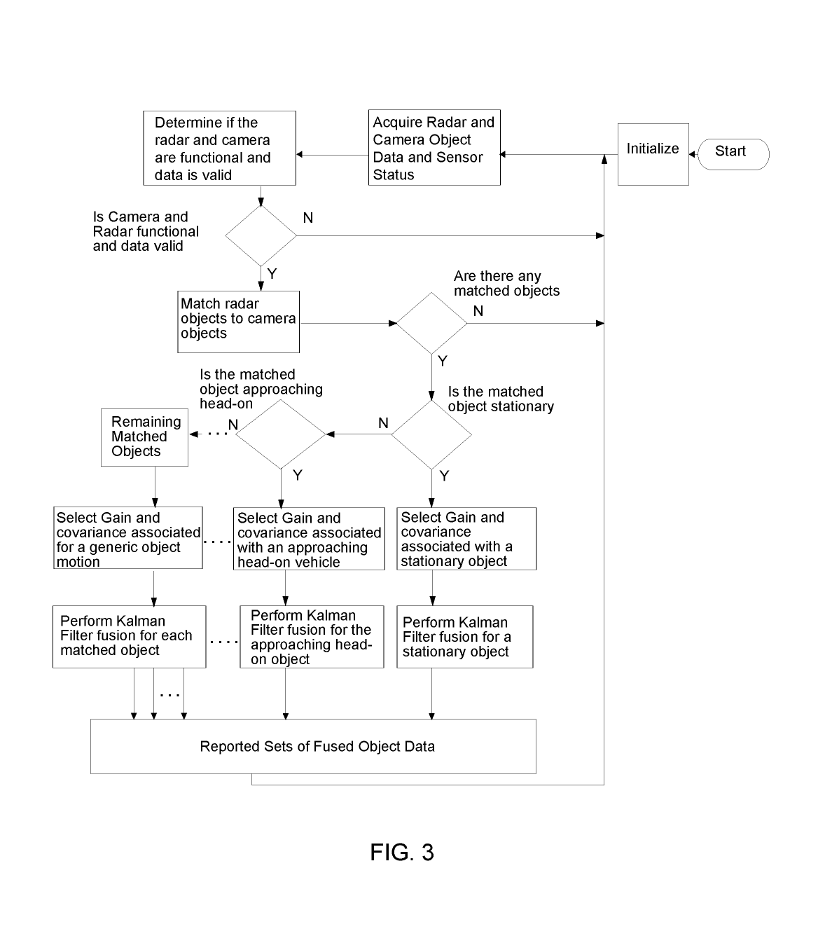

The process of the system of the present invention is shown in FIG. 3. After initialization of all Kalman Filter processing variables, radar and camera data and sensor status are acquired and processed to evaluate the environmental sensors (hereinafter referred to as radar and camera, but could be other sensors) to determine the diagnostics status and to determine if the radar and camera are functional and the data is valid. The fusion processing continues if the sensor(s) diagnostics are passed and the object data is determined to be valid. Otherwise, fusion processing is halted until diagnostics are passed and data is valid.

If the data is valid, the system processes the data to match radar objects to camera objects. The radar and camera data are evaluated to determine which radar and camera object data sets have similar location and motion characteristics. If there are no matched objects for the particular set of collected data, fusion processing is halted until the next set of radar and camera data is available for processing.

If there are matched objects and sets of matched radar and camera data are collected, analyzed and processed, object motion and location characteristics are compared to a set of predefined situations. The flowchart illustrates only two situations (object stationary and object approaching head-on to the equipped vehicle). There can be more situations depending on the application(s) utilizing the sensor data. The two identified example situations focus on vehicles approaching head-on and stationary vehicles.

If the object data is characterized as an identified situation, the corresponding gain calibrations are selected. These calibrations utilized in the steady state Kalman filter calculations derive a single set of object location and motion data. This is performed for each matched pair of radar and camera data. The Kalman filter fusion processing determines the estimated object location k which is calculated by means of equation (5):

\hat{x}ₖ=\hat{x}ₖ⁻+K_{radar,k}(y_{radar,k}−C_{radar,k}*\hat{x}ₖ⁻)+K_{camera,k}(y_{camera,k}−C_{camera,k}*\hat{x}ₖ⁻) (5)

In equation (5), the variables include measured sensor data, y_{radar,k} and y_{camera,k}, the constant Kalman Gains K_{radar,k} and K_{camera,k}, measurement matrices C_{radar,k} and C_{camera,k} and the previously predicted state \hat{x}ₖ⁻. The Kalman gains K_{radar,k} and K_{camera,k} are determined based on measurement and process covariance. As measurement covariance might be depending on driving situation or environmental conditions, Kalman gains have to change accordingly.

The updated measurement estimate is used to predict the future state of the object \hat{x}ₖ₊₁⁻ which is calculated by means of equation (6) below. The variables include the result of (5) and an object motion model Aₖ.

\hat{x}ₖ₊₁⁻=Aₖ\hat{x}ₖ (6)

There is a set of Kalman filter fusion calculations for each set of matched radar and camera objects. For example, if there are four matched objects then there are four sets of steady state Kalman filters. The complete set of outputted fused object data is utilized by other user specific functions downstream of the fusion processing.

Thus, if the system determines that the object is stationary, the system selects a gain and covariance associated with a stationary object and performs the appropriate Kalman Filter fusion for a stationary object. If the system does not determine that the object is stationary, the system determines whether or not the object is approaching head-on. If the system determines that the object is approaching head-on, the system selects a gain and covariance associated with an approaching head-on vehicle and performs the appropriate Kalman Filter fusion for the approaching head-on object. If the system does not determine that the object is approaching head-on, the system selects a gain and covariance associated with a generic object motion (and not a stationary object or head-on approaching object) and performs the appropriate Kalman Filter fusion for each matched object. After the Kalman Filter fusions are performed, the system reports or generates sets of fused object data and returns to the beginning to acquire data and repeat the process for subsequent data captures.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in International Publication Nos. WO 2013/081984 and/or WO 2013/081985, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an EyeQ2 or EyeQ3 image processing chip available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle. Optionally, responsive to such image processing, and when an object or other vehicle is detected, the system may provide automatic braking and/or steering of the vehicle to avoid or mitigate a potential collision with the detected object or other vehicle.

The vehicle may include any type of sensor or sensors, such as imaging sensors or radar sensors or lidar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or International Publication Nos. WO 2011/028686; WO 2010/099416; WO 2012/061567; WO 2012/068331; WO 2012/075250; WO 2012/103193; WO 2012/0116043; WO 2012/0145313; WO 2012/0145501; WO 2012/145818; WO 2012/145822; WO 201 2/1 581 67; WO 2012/075250; WO 2012/0116043; WO 2012/0145501; WO 2012/154919; WO 2013/019707; WO 2013/016409; WO 2013/019795; WO 2013/067083; WO 2013/070539; WO 2013/043661; WO 2013/048994; WO 2013/063014, WO 2013/081984; WO 2013/081985; WO 2013/074604; WO 2013/086249; WO 2013/103548; WO 2013/109869; WO 2013/123161; WO 2013/126715; WO 2013/043661 and/or WO 2013/158592, which are all hereby incorporated herein by reference in their entireties. The system may communicate with other communication systems via any suitable means, such as by utilizing aspects of the systems described in International Publication Nos. WO/2010/144900; WO 2013/043661 and/or WO 2013/081985, and/or U.S. Pat. No. 9,126,525 which are hereby incorporated herein by reference in their entireties.

The camera module and circuit chip or board and imaging sensor may be implemented and operated in connection with various vehicular vision-based systems, and/or may be operable utilizing the principles of such other vehicular systems, such as a vehicle headlamp control system, such as the type disclosed in U.S. Pat. Nos. 5,796,094; 6,097,023; 6,320,176; 6,559,435; 6,831,261; 7,004,606; 7,339,149 and/or 7,526,103, which are all hereby incorporated herein by reference in their entireties, a rain sensor, such as the types disclosed in commonly assigned U.S. Pat. Nos. 6,353,392; 6,313,454; 6,320,176 and/or 7,480,149, which are hereby incorporated herein by reference in their entireties, a vehicle vision system, such as a forwardly, sidewardly or rearwardly directed vehicle vision system utilizing principles disclosed in U.S. Pat. Nos. 5,550,677; 5,670,935; 5,760,962; 5,877,897; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978 and/or 7,859,565, which are all hereby incorporated herein by reference in their entireties, a trailer hitching aid or tow check system, such as the type disclosed in U.S. Pat. No. 7,005,974, which is hereby incorporated herein by reference in its entirety, a reverse or sideward imaging system, such as for a lane change assistance system or lane departure warning system or for a blind spot or object detection system, such as imaging or detection systems of the types disclosed in U.S. Pat. Nos. 7,881,496; 7,720,580; 7,038,577; 5,929,786 and/or 5,786,772, which are hereby incorporated herein by reference in their entireties, a video device for internal cabin surveillance and/or video telephone function, such as disclosed in U.S. Pat. Nos. 5,760,962; 5,877,897; 6,690,268 and/or 7,370,983, and/or U.S. Publication No. US-2006-0050018, which are hereby incorporated herein by reference in their entireties, a traffic sign recognition system, a system for determining a distance to a leading or trailing vehicle or object, such as a system utilizing the principles disclosed in U.S. Pat. Nos. 6,396,397 and/or 7,123,168, which are hereby incorporated herein by reference in their entireties, and/or the like.

Optionally, the vision system may include a display for displaying images captured by one or more of the imaging sensors for viewing by the driver of the vehicle while the driver is normally operating the vehicle. Optionally, for example, the vision system may include a video display device, such as by utilizing aspects of the video display systems described in U.S. Pat. No. 6,690,268 and/or U.S. Publication No. US-2012-0162427, which are hereby incorporated herein by reference in their entireties. The video display may comprise any suitable devices and systems and optionally may utilize aspects of the display systems described in U.S. Pat. Nos. 7,370,983; 7,329,013; 7,308,341; 7,289,037; 7,249,860; 7,004,593; 4,546,551; 5,699,044; 4,953,305; 5,576,687; 5,632,092; 5,677,851; 5,708,410; 5,737,226; 5,802,727; 5,878,370; 6,087,953; 6,173,508; 6,222,460; 6,513,252 and/or 6,642,851, and/or U.S. Publication No. US-2006-0061008, which are all hereby incorporated herein by reference in their entireties.

Optionally, the vision system (utilizing the forward facing camera and a rearward facing camera and other cameras disposed at the vehicle with exterior fields of view) may be part of or may provide a display of a top-down view or birds-eye view system of the vehicle or a surround view at the vehicle, such as by utilizing aspects of the vision systems described in International Publication Nos. WO 2010/099416; WO 2011/028686; WO 2012/075250; WO 2013/019795; WO 2012/075250; WO 2012/145822; WO 2013/081985; WO 2013/086249 and/or WO 2013/109869, and/or U.S. Publication No. US-2012-0162427, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vision system of a vehicle, said vision system comprising:
a camera configured to be disposed at a vehicle equipped with said vision system so as to have a field of view exterior of the equipped vehicle;
wherein said camera comprises a pixelated imaging array having a plurality of photosensing elements;
a non-imaging sensor configured to be disposed at the equipped vehicle so as to have a field of sensing exterior of the equipped vehicle;
wherein, with said camera and said non-imaging sensor disposed at the equipped vehicle, the field of view of said camera at least partially overlaps the field of sensing of said non-imaging sensor at an overlapping region;
a processor operable to process image data captured by said camera and sensor data captured by said non-imaging sensor;
wherein, with said camera and said non-imaging sensor disposed at the equipped vehicle, said processor is operable to process captured image data and captured sensor data to determine a driving situation of the equipped vehicle; and
wherein, responsive to determination by said processor of the driving situation by processing of captured image data and captured sensor data, Kalman Filter parameters associated with the determined driving situation are determined, and, using the determined Kalman Filter parameters, a Kalman Filter fusion is determined, and wherein the determined Kalman Filter fusion is applied to captured image data and captured sensor data to determine an object present in the overlapping region.

2. The vision system of claim 1, wherein said processor is operable to process captured image data and captured sensor data to match objects determined, via processing of captured image data, to be present in the overlapping region and objects determined, via processing of captured sensor data, to be present in the overlapping region, and wherein, responsive to matching of determined objects, said processor determines if the matched objects are stationary or moving and Kalman Filter parameters associated with the determined matched objects are determined.

3. The vision system of claim 2, wherein the Kalman Filter parameters comprise a gain and covariance.

4. The vision system of claim 3, wherein, responsive to matching of objects, said processor determines if a moving object is indicative of an approaching head-on vehicle and, responsive to determination that the moving object is indicative of an approaching head-on vehicle, a gain and covariance associated with an approaching head-on vehicle are determined, and wherein, using the determined gain and covariance, the Kalman Filter fusion is determined.

5. The vision system of claim 3, wherein, responsive to matching of objects, said processor determines if a moving object is not indicative of an approaching head-on vehicle and, responsive to determination that the moving object is not indicative of an approaching head-on vehicle, a gain and covariance associated with other object motion are determined, and wherein, using the determined gain and covariance, the Kalman Filter fusion is determined.

6. The vision system of claim 1, wherein said processor is operable to process captured image data and captured sensor data to match objects determined, via processing of captured image data, to be present in the overlapping region and objects determined, via processing of captured sensor data, to be present in the overlapping region, and wherein, responsive to matching of determined objects, said processor determines a classification of the matched objects and Kalman Filter parameters associated with the determined matched objects are determined.

7. The vision system of claim 6, wherein the determined classification comprises one of (i) a vehicle cutting in front of the equipped vehicle and (ii) a vehicle stopped in front of the equipped vehicle.

8. The vision system of claim 1, wherein the Kalman Filter parameters comprise a gain and covariance.

9. The vision system of claim 1, wherein said non-imaging sensor comprises a radar sensor.

10. The vision system of claim 1, wherein said non-imaging sensor comprises one of a lidar sensor and an ultrasonic sensor.

11. The vision system of claim 1, wherein said processor is operable to communicate via a vehicle-to-vehicle communication system of the equipped vehicle.

12. The vision system of claim 1, wherein said camera has a field of view forward of the equipped vehicle and wherein said non-imaging sensor has a field of sensing forward of the equipped vehicle.

13. A vision system of a vehicle, said vision system comprising:
a camera configured to be disposed at a vehicle equipped with said vision system so as to have a field of view exterior and forward of the equipped vehicle;
wherein said camera comprises a pixelated imaging array having a plurality of photosensing elements;
a non-imaging sensor configured to be disposed at the equipped vehicle so as to have a field of sensing exterior and forward of the equipped vehicle, wherein said non-imaging sensor comprises one of a radar sensor and a lidar sensor;
wherein, with said camera and said non-imaging sensor disposed at the equipped vehicle, the field of view of said camera at least partially overlaps the field of sensing of said non-imaging sensor at an overlapping region;
a processor operable to process image data captured by said camera and sensor data captured by said non-imaging sensor;
wherein, with said camera and said non-imaging sensor disposed at the equipped vehicle, said processor is operable to process captured image data and captured sensor data to determine a driving situation of the equipped vehicle;
wherein the determined driving situation comprises a vehicle cutting in front of the equipped vehicle; and
wherein, responsive to determination by said processor of the driving situation by processing of captured image data and captured sensor data, Kalman Filter parameters associated with the determined driving situation are determined.

14. The vision system of claim 13, wherein said processor is operable to process captured image data and captured sensor data to match objects determined, via processing of captured image data, to be present in the overlapping region and objects determined, via processing of captured sensor data, to be present in the overlapping region, and wherein, responsive to matching of determined objects, said processor determines if the matched objects are stationary or moving and Kalman Filter parameters associated with the determined matched objects are determined.

15. The vision system of claim 13, wherein the Kalman Filter parameters comprise a gain and covariance.

16. The vision system of claim 13, wherein said processor is operable to process captured image data and captured sensor data to match objects determined, via processing of captured image data, to be present in the overlapping region and objects determined, via processing of captured sensor data, to be present in the overlapping region, and wherein, responsive to matching of determined objects, said processor determines a classification of the matched objects and Kalman Filter parameters associated with the determined matched objects are determined.

17. The vision system of claim 13, wherein, using the determined Kalman Filter parameters, a Kalman Filter fusion is determined, and wherein the determined Kalman Filter fusion is applied to captured image data and captured sensor data to determine an object present in the overlapping region.

18. A vision system of a vehicle, said vision system comprising:
a camera configured to be disposed at a vehicle equipped with said vision system so as to have a field of view exterior and forward of the equipped vehicle;
wherein said camera comprises a pixelated imaging array having a plurality of photosensing elements;
a non-imaging sensor configured to be disposed at the equipped vehicle so as to have a field of sensing exterior and forward of the equipped vehicle, wherein said non-imaging sensor comprises one of a radar sensor and a lidar sensor;
wherein, with said camera and said non-imaging sensor disposed at the equipped vehicle, the field of view of said camera at least partially overlaps the field of sensing of said non-imaging sensor at an overlapping region;
a processor operable to process image data captured by said camera and sensor data captured by said non-imaging sensor;
wherein, with said camera and said non-imaging sensor disposed at the equipped vehicle, said processor is operable to process captured image data and captured sensor data to determine a driving situation of the equipped vehicle;
wherein, responsive to determination by said processor of the driving situation by processing of captured image data and captured sensor data, Kalman Filter parameters associated with the determined driving situation are determined; and
wherein said processor is operable to process captured image data and captured sensor data to match objects determined, via processing of captured image data, to be present in the overlapping region and objects determined, via processing of captured sensor data, to be present in the overlapping region.

19. The vision system of claim 18, wherein, responsive to matching of determined objects, said processor determines if the matched objects are stationary or moving and Kalman Filter parameters associated with the determined matched objects are determined.

20. The vision system of claim 18, wherein, using the determined Kalman Filter parameters, a Kalman Filter fusion is determined, and wherein the determined Kalman Filter fusion is applied to captured image data and captured sensor data to determine an object present in the overlapping region.
